(19) United States
(12) Patent Application Publication
(10) Pub. No.: US 2017/0023802 A1
(43) Pub. Date: Jan. 26, 2017

(54) ANTI-GLARE SPECTACLES PROVIDED WITH AN AUTOMATIC SWITCHING DEVICE

(71) Applicant: Valeo Vision, Bobigny Cedex (FR)

(72) Inventors: Hafid El Idrissi, Pantin (FR); David Hue, Butry Sur Oise (FR)

(21) Appl. No.: 15/214,816

(22) Filed: Jul. 20, 2016

(30) Foreign Application Priority Data
Jul. 23, 2015 (FR) 1556981

(51) Int. Cl. G02C 7/10; G02C 7/12; G02C 7/16

(52) U.S. Cl. CPC G02C 7/101; G02C 7/16; G02C 7/12; G02C 7/104

(57) ABSTRACT

A pair of anti-glare spectacles, intended to be worn by a user, the spectacles comprising at least one anti-glare screen that can be switched between a first state in which the screen is capable of allowing the vision of the user and a second state in which the screen is capable of occulting the vision of the user, the spectacles further comprising an automatic switching device configured to detect a geographic configuration of the spectacles in order to switch the anti-glare screen to the second state when the spectacles have a geographic configuration which belongs to a set of predetermined geographic configurations, and to switch the anti-glare screen to the first state, when the spectacles have a geographic configuration which does not belong to the set.

### CROSS-REFERENCE TO RELATED APPLICATIONS

This application claims priority to the French application 1556981 filed Jul. 23, 2015, which applications are incorporated herein by reference and made a part hereof.

### BACKGROUND OF THE INVENTION

1. Field of the Invention

The present invention relates to anti-glare spectacles provided with an automatic switching device.

2. Description of the Related Art

In a certain number of situations, one or more elements present in the road scene can disturb a clear view of this road scene, and in particular can dazzle the driver or the passengers. While the passengers can divert the gaze from the road scene to avoid being dazzled, the driver cannot allow his or her eyes to leave the road scene for obvious safety reasons.

These situations can be encountered in daytime, when the outside brightness is variable in significant proportions, for example in sunny weather, when various events can alternately strongly illuminate the road scene and darken it. These situations can also be encountered at night, when the outside brightness is weak, and requires low beam (also called dipped beam) lights to be switched on.

To avoid being dazzled, adaptive anti-glare spectacles have already been proposed for motor vehicle drivers or passengers, the spectacles comprising lenses provided with a screen capable of occulting or of allowing light to pass, the transmission coefficient of the spectacles being defined by pulse width modulation. Since the modulation is applied electronically, the spectacles require the use of batteries to control the screen.

Consequently, the spectacles are also provided with a switch to switch them on, then to switch them off when they are not being used. Thus, the energy stored in the batteries is used sparingly in order in particular not to have to recharge them often and to always have them in running order.

However, the use of these spectacles involves handling which is not easy when a driver wants to use them while driving. In effect, he or she must press on the switch a first time to switch them on and a second time to switch them off when he or she has no further use for them. For safety reasons, the driver is either obliged to stop to switch them on or switch them off, or obliged to leave them constantly switched on so as not to have to perform these manipulations, which reduces the benefit of such a switch.

### SUMMARY OF THE INVENTION

The aim of the invention is to remedy these drawbacks, and aims to provide a pair of anti-glare spectacles which switch on automatically when the user wears them and switch off automatically when he or she removes them without recourse to an additional operation.

For that, the invention relates to anti-glare spectacles, intended to be worn by a user, the spectacles comprising at least one anti-glare screen that can be switched between a first state in which the screen is capable of allowing the vision of the user and a second state in which the screen is capable of occulting the vision of the user, the spectacles further comprising an automatic switching device configured to detect a geographic configuration of the spectacles in order to switch the anti-glare screen to the second state when the spectacles have a geographic configuration which belongs to a set of predetermined geographic configurations, and to switch the anti-glare screen to the first state, when the spectacles have a geographic configuration which does not belong to the set.

Thus, the spectacles operate automatically when they are positioned in the predetermined zone and cease to function when they are outside, without the need to use a switch. By defining, for example, the predetermined zone at the level of the face of a user, it is sufficient for the user to place the spectacles on his or her nose to trigger the operation thereof. When the user removes them, the spectacles switch off automatically.

By virtue of the invention, the batteries of the spectacles are used sparingly, which makes it possible to recharge them less often, and therefore avoid an untimely stop while operating.

According to different embodiments of the invention, which will be able to be taken together or separately:
the geographic configurations are determined positions and/or orientations and/or inclinations and/or movements of the spectacles in a given reference frame,
the geographic configuration of the spectacles is the position thereof in space,
the set of geographic configurations defines at least one predetermined zone in space,
the switching device comprises a memory unit in which the set is stored,
the occulting by the anti-glare screen is partial,
the occulting by the anti-glare screen is substantially complete,
the switching device comprises a first sensor in order to determine a position of the spectacles,
the first sensor is an inertial sensor,
the first sensor is integrated in a frame of the spectacles,
the switching device comprises a second sensor arranged at a distance from the spectacles to determine a relative position of the spectacles,
the automatic switching device comprises a camera arranged at a distance from the frame of the spectacles and configured to detect the spectacles when they are in the predetermined zone,
the automatic switching device comprises means for controlling the switching of the screen according to the position of the spectacles,
the anti-glare screen is provided with a variable transmission coefficient,
the transmission coefficient is determined by pulse width modulation with a determined duty cycle,
the modulation is performed at fixed frequency with a variable duty cycle,
the spectacles comprise means for controlling the duty cycle,
the spectacles comprise at least one lens, the anti-glare screen being borne by the lens,
the anti-glare screen is arranged on a second side of the lens, the incident light being intended to pass through the lens from the second side of the lens to a first side,
the anti-glare screen is provided with a vertical polarization layer and a horizontal polarization layer,
the anti-glare screen is provided with an activatable liquid crystal layer arranged between the two polarization layers.

The invention relates also to a device for assisting in the driving of a motor vehicle, notably at night, comprising anti-glare spectacles provided with an automatic switching device according to the invention. If appropriate, the predetermined zone or zones are zones defined in the interior of the vehicle.

These and other objects and advantages of the invention will be apparent from the following description, the accompanying drawings and the appended claims.

### BRIEF DESCRIPTION OF THE ACCOMPANYING DRAWINGS

The invention will be better understood in light of the following description which is given in a purely indicative and nonlimiting manner, accompanied by the attached drawings in which:

FIG. 1 schematically illustrates a perspective view of a pair of anti-glare spectacles; and

FIG. 2 schematically illustrates a perspective view of a pair of anti-glare spectacles provided with an automatic switching device according to the invention.

### DETAILED DESCRIPTION OF THE PREFERRED EMBODIMENTS

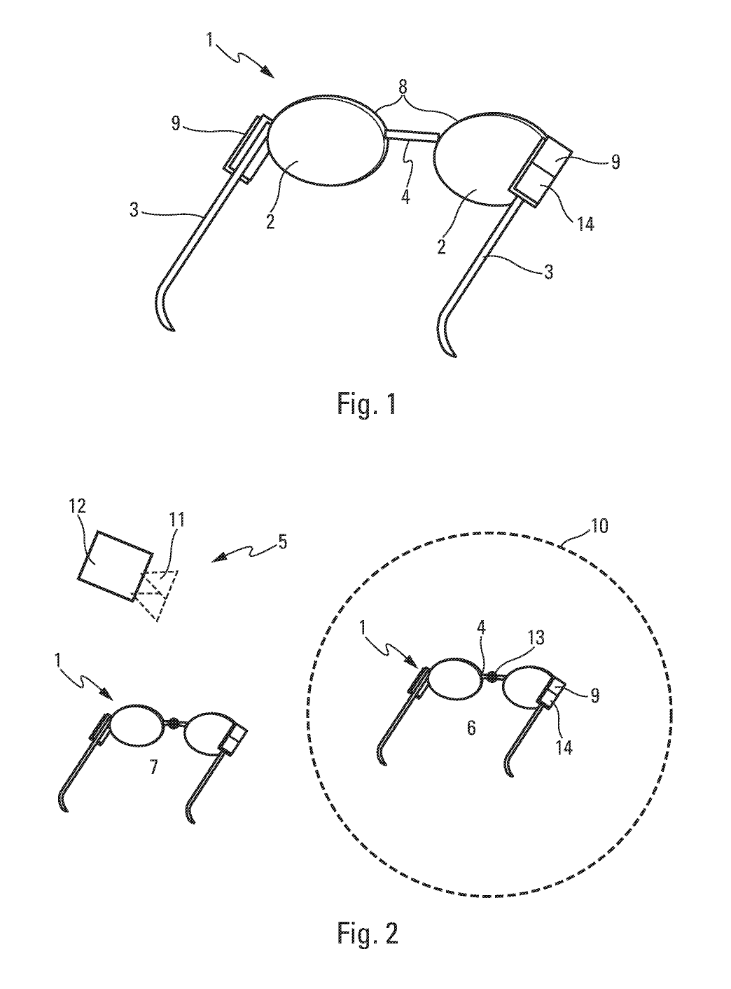

As illustrated in FIG. 1, the spectacles 1 here have two lenses 2, two earpieces 3 and a frame 4 to which the lenses 2 are fixed. In the description of the invention, the term lens denotes the object fixed to the frame 4 and through which the wearer of the spectacles 1 watches the scene in front of him or her. The lens 2 can be manufactured in a mineral or organic glass material for example, but also in any other material known to those skilled in the art for this purpose.

The wearer or user of the spectacles 1 is situated on a first side of the lenses 2, and the scene that he or she observes is situated on a second side of the lenses 2. Thus, the incident light arrives on the lenses 2 by coming from the second side, then passes through them via the outer face of the lenses 2, and reemerges via the inner face toward the wearer of the spectacles 1.

The spectacles 1 further comprise an anti-glare screen 8 that can be switched between a first state in which the anti-glare screen 8 is capable of allowing the vision of the user and a second state in which the anti-glare screen 8 is capable of occulting the vision of the user. The occulting is here partial to make it possible to attenuate the intensity of the incident light intended to pass through the lens 2 to the user. Here, the anti-glare screen 8 is arranged on the second side of the lens 2, for example on the outer face of the lenses 2, on the other side from the user in relation to the spectacles 1.

To reduce the glare, the anti-glare screen 8 is provided with a variable transmission coefficient that makes it possible to attenuate the intensity of the incident light. Depending on the value of the transmission coefficient, the anti-glare screen 8 allows a more or less significant part of the incident light to pass. The transmission coefficient of the anti-glare screen 8 makes it possible to reduce the intensity of the incident light for the comfort of the user. The first state corresponds to a high transmission coefficient, and the second state to a lower transmission coefficient.

The transmission coefficient is determined by pulse width modulation. The modulation is performed at fixed frequency, preferably at at least 100 Hz, with a duty cycle defining the transmission coefficient of the anti-glare screen 8. The anti-glare screen 8 therefore has a light transmission coefficient which varies periodically between:

a maximum value, for which the transparency is maximum during a time t1, and a minimum value, for which the transparency is minimal during a time t2.

A duty cycle α is determined by the ratio between the time t1 during which the transmission is maximum, and the time T of the period, and therefore varies from 0 to 100%:

$$α = \frac{{t}_{1}}{T}$$

By modifying the duty cycle α, the time t1 during which the transparency is maximum is extended or shortened, relative to the time t2 during which the light does not pass. Thus, by increasing t1, the duty cycle α increases, and by increasing t2, the duty cycle α decreases. As an average value, the transmission coefficient is thus dependent on the value of the duty cycle α.

The scene in front of the wearer of the spectacles 1 is therefore visible only for a fraction of time equal to the duty cycle α. The apparent brightness, through the anti-glare screen 8 with variable transmission, is therefore decreased relative to the real brightness by a factor equal to (1−α).

Furthermore, the spectacles 1 are configured to adapt the transmission coefficient of the anti-glare screen 8 according to the intensity of the incident light. The spectacles 1 in this way make it possible to protect it from significant brightness. For that, the spectacles 1 comprise means 9 for controlling the transmission coefficient arranged here on the earpieces 3 of the spectacles 1, close to the anti-glare screen 8. The transmission coefficient is controlled either as instantaneous value, or as average value. For example, by choosing a determined duty cycle, a corresponding transmission coefficient is defined.

Thus, the duty cycle α is variable and chosen as a function of the light intensity of the incident light. In order to measure the light intensity of the incident light, the spectacles 1 will be able to include a brightness sensor, not represented in the figures, which supplies a measurement of the intensity to the control means 9. The control means 9 determine the value of the duty cycle α as a function of this measurement.

The spectacles 1 are also provided with one or more batteries 14 or cells, which provide the energy necessary to the operation of the anti-glare screens 8 of the spectacles 1. The batteries 14 are preferably arranged with the control means 9, in the earpieces 3.

In a first embodiment, the anti-glare screen 8 is provided with a vertical polarization layer and a horizontal polarization layer, arranged on the lens 2, and a liquid crystal layer arranged between the two polarization layers. The polarization layers each polarize the incident light in a different direction. In the liquid crystal layer, the direction of the polarized light is modified by the liquid crystals. The orientation of the liquid crystals determines the direction of polarization of the light. Thus, when they are oriented in a direction which modifies the polarization in a same direction as that of the following polarization layer, the light passes through. On the other hand, if the direction is different, the light is not transmitted to the wearer of the spectacles 1.

Thus, the modulation is performed by orienting the liquid crystals in the same direction as that of the following polarization layer during the time t1, to transmit the light, then by orienting it in a different direction during the time t2, to block the light.

In a second embodiment, the anti-glare screen 8 is provided with a micro-electro-mechanical layer of MEMS (micro-electro-mechanical system) type, arranged on the lens 2. This layer is made up of microelectronic elements that can be electrically actuated, which block the incident light or allow it to pass. The micro-electro-mechanical systems are, for example, of the type described in U.S. Pat. No. 7,684,105. Here, the modulation is performed by allowing the incident light to pass during the time t1, and by blocking it during the time t2, by actuation of the micro-electro-mechanical layer.

As shown in FIG. 2, the spectacles 1 comprise an automatic switching device 5 to avoid complicated procedures and to save the energy of the batteries 14. The switching device 5 is configured to define a set of geographic configurations, here a predetermined zone 10, in which the spectacles 1 operate automatically. In other words, the anti-glare screens 8 are switched to the second state when the spectacles 1 are in this predetermined zone 10, without the user having to personally trigger the switching of the anti-glare screens 8.

For that, the switching device 5 is configured to detect the position 6, 7 of the spectacles 1 in order to be able to switch the anti-glare screens 8 to the second state when the spectacles 1 have a position 6 which belongs to the predetermined zone 10, and to switch the screens 8 to the first state, when the spectacles 1 have a position 7 outside of the predetermined zone 10. The automatic switching device 5 further comprises means 12 for controlling the switching of the anti-glare screens 8 through control means 9.

In a first embodiment, represented in FIG. 2, the switching device 5 comprises a camera 11 for detecting the position 6, 7 of the spectacles 1, and which is linked to the control means 12. The camera 11 and the control means 12 are arranged at a distance from the frame 4 of the spectacles 1. The control means 12 have, for example, image processing software suitable for recognizing spectacles 1. Advantageously, the frame 4 is provided with a distinctive sign 13 that can easily be recognized by the camera 11 and the control means 12. The control means 12 are further provided with a transmitter and the spectacles 1 are provided with a receiver, for transmitting to the control means 9 of the spectacles 1 an anti-glare screen switching command.

Thus, by virtue of the camera 11, when the control means 12 detect that the spectacles 1 are in a first position 6 situated inside the predetermined zone 10, they control the switching of the anti-glare screens 8 for the second state, preferably according to the method described previously. And when the control means 12 detect that the spectacles 1 are in a second position 7, situated outside the predetermined zone 10, they transmit to the control means 9 a command to switch the anti-glare screens 8 to the first state.

Preferably, the control means 12 are configured to control the switching of the anti-glare screens 8 as soon as the control means 12 detect the spectacles 1 in the field of view of the camera 11. Thus, the predetermined zone 10 is defined by the field of view of the camera 11.

For example, for a use in a motor vehicle, the control means 12 and the camera 11 are, for example, arranged in the dashboard of the vehicle. The field of view of the camera 11 is directed upward from the seat of the vehicle, for example that of the driver, so as to be able to detect whether the driver is wearing the spectacles 1 on his or her face. By virtue of the invention, as soon as the driver puts on the spectacles 1 to avoid being dazzled, the spectacles 1 are automatically switched to the second state, without involving the operation of a switch. And, in order to save the energy of the batteries 14, when the driver removes the spectacles 1, they are automatically switched to the first state, here by stopping the modulation of the anti-glare screens 8.

In a second embodiment, not represented in the figures, the automatic switching device 5 comprises a first inertial sensor integrated in the frame 4 of the spectacles 1 in order to determine the position of the spectacles 1. The means 12 for controlling the switching of the spectacles 1 are for example integrated in the frame 4 of the spectacles 1. The inertial sensor makes it possible to determine a position of the spectacles 1, which is transmitted to the control means 12 so that they determine whether the spectacles 1 are in a predetermined zone 10. The predetermined zone 10 is for example chosen around a reference position of the vehicle interior. The use and the operation of the spectacles 1 is the same as in the first embodiment.

In a variant of the second embodiment, the switching device 5 comprises, in addition to a first sensor integrated in the frame 4 of the spectacles 1, a second inertial sensor arranged at a distance from the frame 4 of the spectacles 1, for example in the dashboard of the vehicle. Thus, that makes it possible to determine a relative position of the first sensor relative to the second sensor, and consequently spectacles 1 relative to the dashboard. The predetermined zone 10 is here defined relative to the second inertial sensor, which is fixed. When the first sensor is in the predetermined zone 10, the spectacles 1 are switched to the second state, then to the first state when the first sensor is no longer in the zone 10. The switching device 5 also comprises a transmitter and a receiver for transmitting the relative position between the two sensors.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. Anti-glare spectacles, intended to be worn by a user, said anti-glare spectacles comprising at least one anti-glare screen that can be switched between a first state in which said at least one anti-glare screen is capable of allowing the vision of the user and a second state in which said at least one anti-glare screen is capable of occulting the vision of the user, said anti-glare spectacles further comprising an automatic switching device configured to detect a geographic configuration of said anti-glare spectacles in order to switch said at least one anti-glare screen to said second state when said anti-glare spectacles have a geographic configuration which belongs to a set of predetermined geographic configurations, and to switch said at least one anti-glare screen to said first state, when said anti-glare spectacles have a geographic configuration which does not belong to said set of predetermined geographic configurations.

2. The anti-glare spectacles according to claim 1, in which said geographic configuration of said anti-glare spectacles is a position thereof in space, and said set of predetermined geographic configurations defines at least one predetermined zone in space.

3. The anti-glare spectacles according to claim 2, in which said automatic device comprises a first sensor suitable for determining a position of said anti-glare spectacles.

4. The anti-glare spectacles according to claim 3, in which said automatic switching device comprises a second sensor arranged at a distance from said anti-glare spectacles to determine a relative position of said anti-glare spectacles.

5. The anti-glare spectacles according to claim 2, in which said automatic switching device comprises a camera arranged at a distance from a frame of said anti-glare spectacles and configured to detect said anti-glare spectacles when they are in said at least one predetermined zone.

6. The anti-glare spectacles according to glare 2, in which said automatic switching device comprises means for controlling the switching of said at least one anti-glare screen according to said geographic configuration of said anti-glare spectacles.

7. The anti-glare spectacles according to claim 1, in which said at least one anti-glare screen is provided with a variable transmission coefficient.

8. The anti-glare spectacles according to claim 7, in which said variable transmission coefficient is determined by pulse width modulation with a determined duty cycle.

9. The anti-glare spectacles according to claim 8, in which said pulse width modulation is performed at fixed frequency with a variable duty cycle.

10. The anti-glare spectacles according to claim 9, in which said anti-glare spectacles comprise means for controlling said variable duty cycle.

11. The anti-glare spectacles according to claim 1, comprising at least one lens, said at least one anti-glare screen being borne by said at least one lens.

12. The anti-glare spectacles according to claim 11, in which said at least one anti-glare screen is arranged on a second side of said at least one lens, the incident light being intended to pass through said at least one lens from said second side of said at least one lens to a first side.

13. The anti-glare spectacles according to claim 1, in which said at least one anti-glare screen is provided with a vertical polarization layer and a horizontal polarization layer.

14. The anti-glare spectacles according to claim 13, in which said at least one anti-glare screen is provided with an activatable liquid crystal layer arranged between said vertical polarization layer and said horizontal polarization layer.

15. A device for assisting in the driving of a motor vehicle, notably at night, comprising said anti-glare spectacles provided with said automatic switching device according to claim 1.

16. The anti-glare spectacles according to claim 3, in which said automatic switching device comprises a camera arranged at a distance from a frame of said anti-glare spectacles and configured to detect said anti-glare spectacles when they are in said at least one predetermined zone.

17. The anti-glare spectacles according to claim 4, in which said automatic switching device comprises a camera arranged at a distance from a frame of said anti-glare spectacles and configured to detect said anti-glare spectacles when they are in said at least one predetermined zone.

18. The anti-glare spectacles according to claim 3, in which said automatic switching device comprises means for controlling the switching of said at least one anti-glare screen according to said geographic configuration of said anti-glare spectacles.

19. The anti-glare spectacles according to claim 4, in which said automatic switching device comprises means for controlling the switching of said at least one anti-glare screen according to said geographic configuration of said anti-glare spectacles.

20. The anti-glare spectacles according to claim 5, in which said automatic switching device comprises means for controlling the switching of said at least one anti-glare screen according to said geographic configuration of said anti-glare spectacles.
